(19) United States
(12) Patent Application Publication
(10) Pub. No.: US 2021/0390489 A1
(43) Pub. Date: Dec. 16, 2021

(54) SYSTEM AND METHOD FOR MULTIPLE IDENTIFICATION USING SMART CONTRACTS ON BLOCKCHAINS

(71) Applicant: SHOYO, BORDEAUX (FR)

(72) Inventor: PHILIPPE GABORIEAU, CAMBES (FR)

(21) Appl. No.: 17/284,421

(22) PCT Filed: Dec. 6, 2019
(86) PCT No.: PCT/IB2019/060513

§ 371 Date: Apr. 9, 2021

(30) Foreign Application Priority Data
Oct. 10, 2018 (FR) 1859389

(51) Int. Cl. G06Q 10/06; G06Q 10/10; G06Q 40/06; H04L 9/32

(52) U.S. Cl. CPC G06Q 10/06393; G06Q 10/103; H04L 2209/38; H04L 9/3247; H04L 9/3297; G06Q 40/06

(57) ABSTRACT

A method for electronic identification, on a network, of a first party before at least one second party through the establishment of a time-and-date stamped certified document of data relating to the first party in response to a query of the second party. The query being sent on an application programming interface and includes a plurality of requests to which the first party answers at least partially by sending answers via the application programming interface. The method includes storing the answers in a blockchain and creating the certified document from the query of the second party, the answers of the first party and answers stored beforehand in the blockchain.

### TECHNICAL FIELD

The present invention belongs to the general field of information gathering and sharing, more specifically, of identity and similar information provision for online accounts application. Even more particularly, the invention relates to a customer identification system and method for financial accounts.

The present invention also pertains to blockchain technologies and to smart-contracts.

### BACKGROUND OF THE INVENTION

Usually, the activities of financial institutions, such as banks and insurances, are regulated and controlled. Sometimes, some rules turn out to be complex, for obvious safety reasons, and require, for the application thereof, the set-up of long processes, comprising redundant operations, which may be somehow tedious, to both the customers of the financial institutions and the financial institutions themselves.

Amongst the regulated activities of financial institutions, the customers identification and knowledge procedures, grouped under the acronym KYC (standing for Know Your Customer), are subject to particularly stringent legal requirements, which vary from one country to another, in the context of customers protection, money-laundering fighting and data protection.

In general, KYC refers to due diligence activities relating to customers, conducted by financial institutions and other regulated companies in order to identify their customers and to check up the relevant information in order to be able to perform financial transactions with them, as well as the banking regulation governing these activities.

Although the KYC process is presented herein under its legal and regulatory aspect, it may, in the context of the current digital technology, be applied outside the regulatory conditions.

In order to execute a KYC procedure with regards to a customer, a supplier or a partner, the financial institutions request a determined number of information and require the establishment of supporting documents. At first glance, providing all these elements is a simple formality that the customers could accomplish when there is only one financial request or a limited number of requests. However, when the number of involved financial institutions becomes substantial, providing the required information and documents for the KYC imposed by each of said institutions could quickly turn out to be a particularly time-consuming and daunting task. For example, this situation corresponds to the case of applicants for financing for business creation or launching of various economic projects (startups, sole entrepreneurs, fundraising, etc.). In the case of crowd-funding, to mention only this financing mode usually presented to be effective and easily accessible, it is highly recommended for projects launchers to multiply the requests by subscribing on as many dedicated platforms as possible in order to enhance the fundraising chances. Hence, these multiple subscriptions require the creation of multiple accounts, or profiles, while providing the same information almost each time.

The figure of the prior art illustrates such a situation in which a person is forced to supply, for each financial institution, a number of “answers”, or information, equal to the number of questions that are submitted to him/her by the considered institution. Hence, the person could likely answer the same question several times, in particular questions regarding the identity of the person and his/her marital status, systematically asked by the different financial institutions and more generally by every administrative body.

In some cases, the financial institutions may be partners, grouped together or dependent of the same entity, and consequently share the customers' data. Nonetheless, to date, there is no solution for sharing the data between institutions that are totally independent of each other.

Nevertheless, there are internal backup solutions enabling a financial institution to save the data of its customers for a possible subsequent use of these data. To this end, blockchains provide reliable and secure storage means and are increasingly used in the financial sector.

Besides, because of the cost of the KYC processes that is growing steadily, developments aiming to simplify these KYC processes are becoming ever more numerous. However, these developments primarily seek to simplify the KYC task on the banks and other institutions side and consider less the problem from the customer's perspective.

Most of these developments concern regulation technologies which seek to automate administrative tasks of the KYC by embedding artificial intelligence in the organisation of data and the detection of anomalies.

### OBJECT AND SUMMARY OF THE INVENTION

The present invention aims to overcome the drawbacks of the prior art.

To this end, the present invention relates to a method for electronic identification on a network of a first party before at least one second party through the establishment of a time-and-date stamped certified document of data relating to the first party in response to a query of the second party, the query being sent on an application programming interface and comprising a plurality of requests to which the first party answers at least partially by sending answers via said application programming interface. Advantageously, this method comprises:
a step of storing the answers in a blockchain;
a step of creating the certified document from the query of the second party, the answers of the first party and answers stored beforehand in the blockchain.

Thus, the first party only answers the requests that it has never answered before or those for which the answers have changed. Hence, the creation of the certified document is based on both the “current” answers and the “old” answers registered during the processing of an old query.

Advantageously, the answers given by the first party correspond to a portion of the requests of the query, the other portion of said requests corresponding to other answers stored beforehand in the blockchain and given by said first party in response to requests of another query.

Therefore, the first party no longer gives repetitive answers as is the case with the solutions of the prior art.

More particularly, at least one certified document of data relating to the first party in response to a query of a second party is created from said query, of answers to requests of said query, and of answers to requests of queries of other parties.

According to one embodiment, the identification method comprises:
a step of sending by a second party a query on the application programming interface;
a step of transmitting by the application programming interface the query to the first party;
a step of sending by the first party answers to at least one portion of the requests of said query;
a step of adding by the application programming interface said answers to the blockchain;
a step of sending by the application programming interface the query to said blockchain;
a step of creating and storing by the blockchain a certified document, corresponding to the answer of the first party to all of the requests of the query, from said query and all of the answers stored in the blockchain;
a step of sending by the blockchain the certified document to the application programming interface; and
a step of transmitting by the application programming interface the certified documents to the second party.

Advantageously, each of the four second last steps is monitored by a smart-contract type program.

According to one embodiment, the application programming interface sends a list of requests amongst which each second party selects a set of requests to define its query.

For example, in an application of the invention to the financial sector, the first party, each second party, the query and the certified document respectively consist of an applicant for financing or investor, a financial institution, a customer knowledge questionnaire and a Know Your Customer (KYC) type customer knowledge report.

The present invention also covers a system for electronic identification on a network, for the implementation of a method as described, including an application programming interface and a blockchain.

Advantageously, the blockchain is a consortium blockchain in which each node is governed by a second party.

More particularly, the application programming interface is accessible from a web page type consultation unit.

The fundamental concepts of the invention having been set out hereinabove in their most elementary form, other details and features will come out more clearly on reading the following description and with reference to the appended drawings, providing as a non-limiting example an embodiment of an identification method in accordance with the principles of the invention and of a system for the implementation of said method.

### BRIEF DESCRIPTION OF THE FIGURES

The elements of the same figures, as well as the figures themselves, are not necessarily represented to the same scale. In all figures, identical or equivalent elements bear the same reference numeral.

Thus, there is illustrated in:

FIG. 1 is a block diagram of the prior art;

FIG. 2 is a block diagram of the present invention;

FIG. 3 is a schematic representation of the multiple identification system according to the invention and of the main interactions between its elements;

FIG. 4 is a flowchart depicting the main steps of a multiple identification method according to the invention.

### DETAILED DESCRIPTION OF THE EMBODIMENTS

In the embodiment described hereinafter, reference is made to a multiple identification system and method, intended mainly to an application in the businesses financing field. This non-limiting example is provided for a better understanding of the invention and does not exclude the adaptation of the system and of the method to other applications in other human activities. For example, the invention may be applied to the problem of multiple academic or professional applications requiring the provision of a large portion of common information.

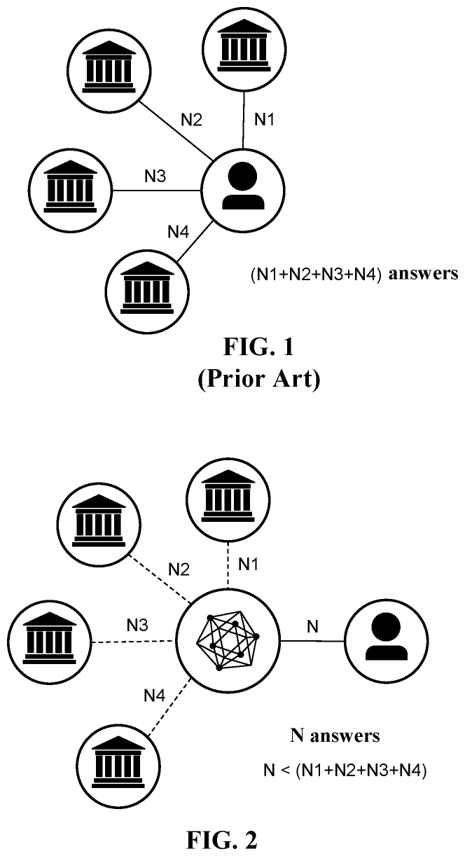

In general, the invention will enable any person, having to answer a multitude of questions originating from different parties, to give a minimised number of answers so as to answer all of the asked questions while never giving the same answer many times. The advantage provided by the invention is schematised in FIG. 2 that shall be considered in comparison with the FIG. 1 of the prior art.

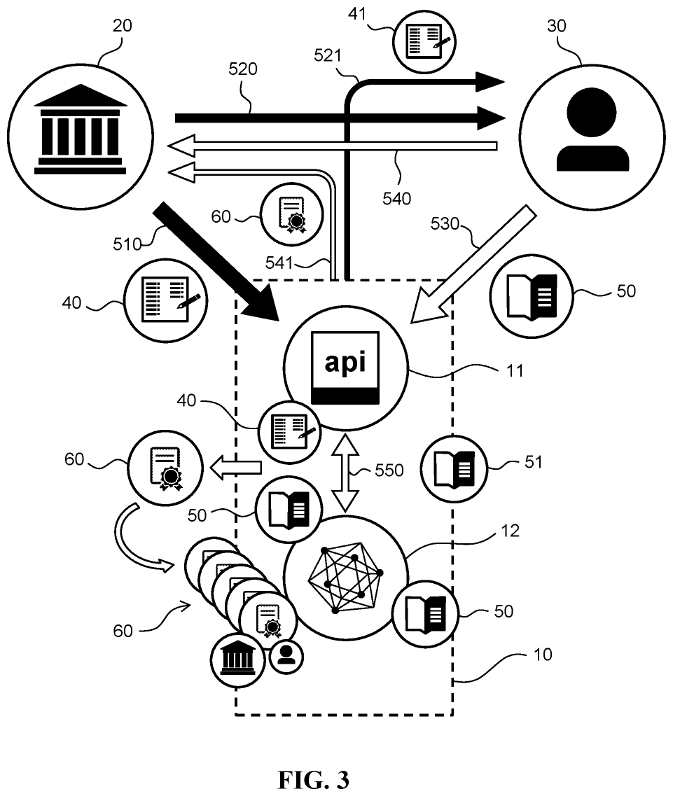

FIG. 3 schematically represents an identification system 10 according to the invention operating between a supplier 20 and a customer 30, the terms “supplier” and “customer” will be used only at an initial stage to better distinguish the roles of these two parties.

For obvious reasons related to clarity, one single supplier is represented in the figures. Nonetheless, it is essential to note that the invention applies, and finds all its usefulness, in the case of a plurality of suppliers and allows facilitating the task of a customer who is confronted with several suppliers.

The identification system 10 mainly includes an application programming interface 11 and a blockchain 12 that will respectively be referred to as API and blockchain in the following description.

In the next paragraph, the main features of a blockchain on which the invention is based are recalled.

A blockchain is a distributed database that manages a list of data protected against falsification or modification. The transactions represent the exchanges between the users of the network, and are stored within the blocks of the blockchain. The different registered transactions are grouped together into blocks. After having registered the recent transactions, a new block is generated and analyzed. If the block is valid, the block could be time-and-date stamped and added to the blockchain. The transactions are then visible throughout the network. When it is added to the blockchain, a block can no longer be modified or deleted, which guarantees the authenticity and the security of the network.

For the following description, the following case is considered: the supplier 20 is a financial institution amongst banks, wealth management companies, trust companies, stock brokerage companies, insurance companies, leasing companies, institutional investors, crowd-funding platforms, etc.; and the customer 30 is an investor. The customer may also correspond to a person looking for an investment for a business creation or a launching of a project with an economic potential, for example the customer is an entrepreneur looking for fundraising for the launch of a startup-type innovative business.

The blockchain 12 is a consortium blockchain shared between a set of financial actors 20 independent of each other, wherein each one of said financial actors constitutes a validation node. Therefore, the elements that will be stored in this blockchain will be characterised by an authenticity that is difficult to contest because of the involvement of different financial actors, subjected to stringent regulations, in the validation of said elements.

This condition is not mandatory and the blockchain may be public or private depending on the application of the invention.

First of all, the multiple identification system will be described throughout the overall operation thereof, and then, the steps of the identification method implemented by said system will be described in more detail.

The overall operation of the identification system may be split into two levels, an external level and an internal level.

The external level corresponds to the interactions between the customer, the financial institution and the identification system considered as a black box. In turn, the internal level pertains to the operations performed inside the system between these different elements.

External Level:

The financial actor 20 needs to know some information and be provided with supporting documents relating to the customer 30 in the context of a KYC procedure.

For this purpose, the financial actor 20 emits a questionnaire model 40 that it wishes to be filled by the customer 30. Hence, step 510 corresponds to a transmission by the financial actor 20 of a questionnaire model 40 to the identification system 10.

The financial actor 20 sends 520 a notification to the customer 30 to request filling of the questionnaire 40. Concomitantly, the system 10 sends to the customer 30 an adapted questionnaire 41 which contains only questions whose answers are note stored in said system.

Indeed, as will be described later on, the system stores all of the answers given by the customer and filters the questions of the questionnaire model sent by the financial actor so as to transmit to the customer only the questions that have no answers stored in said system.

The user fills the adapted questionnaire 41 by providing answers 50. The answers 50 are sent 530 to the system 10.

In fine, the identification system 10 establishes a KYC 60 and transmits it 541 to the financial actor 20 when the customer 30 gives his authorisation 540.

Internal Level:

The definition of the questionnaire model 40 by the financial actor may be carried out either in a free way by said financial actor, or in a guided way, in which case the system sends a set of possible questions to the financial actor who keeps only the questions that interest him to establish his own questionnaire model.

Indeed, the system sends all of the existing questions, the financial actor, by defining its questionnaire model, will have the possibility to customise labels. Thus, the obtained questionnaire model is composed by the identifiers of the retained questions as well as the labels selected by the financial actor.

When the questionnaire model is freely established, the system operates a correspondence between its own questions and the questions of said questionnaire. This correspondence may be carried out in different ways.

Before sending the questionnaire 40 defined by the financial actor 20 to the customer 30, the system 10 sorts out the questions of the questionnaire 40 to establish an adapted questionnaire 41 that contains only the questions for which it has not found answers previously stored in the blockchain 12. For this purpose, the API 11 interacts 550 with the blockchain 12 to look for all possible answers to the questions of the questionnaire 40 corresponding to the customer to whom the questionnaire is sent. To this end, each customer 30 shall be registered on the system via a profile to enable said system to find the answers corresponding to a determined customer.

As regards the unanswered questions, the API generates an adapted questionnaire 41 that it transmits to the customer 30 asking him for answers.

Preferably, the adapted questionnaire 41 includes the questions for which answers have been found in the blockchain, and mentions said questions and answers, in order to enable the customer to have an overview on all of the questions sent by the financial actor and to update some information, where appropriate.

The answers 50 thus given by the customer 30 are retrieved by the API and transmitted to the blockchain. The blockchain systematically stores all the answers given by the customer and thus allows keeping track of the profiles of the customers in the form of registers.

Afterwards, the API fills in the questionnaire 40 of the financial actor with answers 50 originating from the blockchain and with the answers directly given by the customer, and establishes a time-and-date stamped KYC 60, said KYC is then stored in the blockchain which contains all time-and-date stamped KYCs established between the financial actors and the customers having used the identification system.

The stored KYCs may constitute material evidences should a litigation arises. In contrast with existing KYCs, which are not stored in blockchain, the KYCs according to the invention cannot be destroyed and their multiple validations by independent financial actors joined in a consortium increase the degree of reliability and authenticity.

The time-and-date stamped KYC corresponding to the identification of the customer 30 with regards to the financial actor 20 is transmitted to said financial actor subject to the authorisation of said customer.

Considering the foregoing, it becomes obvious that the identification system has a considerable advantage for the processing by the customers of the questionnaires emitted by the financial actors in the context of KYC procedures by enabling each customer to answer only once any question asked several times by different financial actors. Given that for financial actors of the same kind, for example banks, the identification questionnaires are generally similar, the customer can, thanks to the identification system according to the invention, find himself in a situation where all of the questionnaires submitted to him are prefilled with answers given beforehand and stored in the blockchain, in which case all it needs is simply to validate these answers with or without modification.

The method having just been described in general, the following description will set out in more details the different steps of said method.

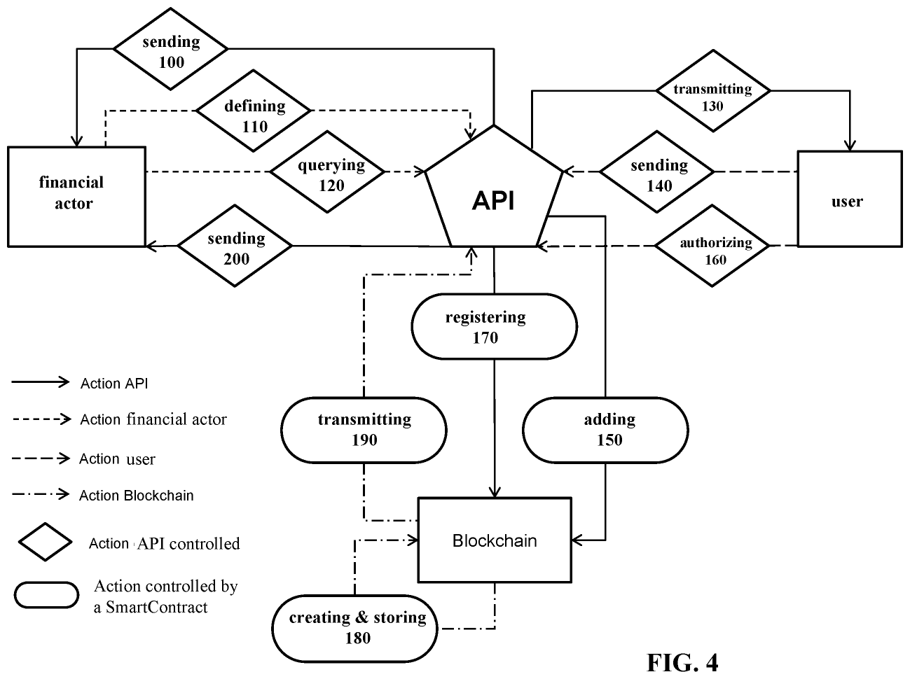

Referring to FIG. 4, the multiple identification method according to the invention comprises in the following sequence:
step 100 of sending a list of questions by the API to at least one financial actor;
step 110 of defining by the financial actor a questionnaire model based on the list of questions, and of sending said questionnaire model to the API;
step 120 of querying a KYC by the financial actor before the API;
step 130 of transmitting the questionnaire model by the API to the user;
step 140 of sending all or part of the answers by the user to the API;
step 150 of adding by the API new answers to the blockchain;
step 160 of authorizing by the user access of the financial actor to the given answers;
step 170 of registering by the API the user authorisation on the blockchain, and of sending the questionnaire model by the API to the blockchain;
step 180 of creating and storing by the blockchain a time-and-date stamped KYC from the questionnaire model and the registered answers;
step 190 of transmitting the time-and-date stamped KYC by the blockchain to the API; and
final step 200 of sending the time-and-date stamped KYC to the financial actor who has requested it.

It is important to note that the communication of the users and of the financial actors with the API is performed through a dedicated platform implementing said API and interacting with the blockchain. For example, such a platform is a web site.

Step 100 of sending the list of questions, amongst which the financial actors shall select to define their models, allows simplifying the processing of the models of questionnaires defined by the financial actors by standardizing the questions constituting said models. This avoids the API having to match the questions in order to properly assign the answers to the questions, and thereby limits the risk of error. Indeed, with the standardisation of the questions, the API assigns the answers to the corresponding questions without any difficulty.

Nonetheless, the method according to the invention could operate without sending pre-established lists of questions. In this case, an additional step of matching the models defined by the financial actors with questions defined beforehand in the API shall be considered.

In addition, step 100 of sending the list of questions is not systematic, it is possible that a financial actor keeps this list for subsequent uses.

For example, the list of questions sent by the API to the financial actors contains multiple-choice questions such as:

Question: “What is your family status?”

Possible answers: “single”, “married”, “in a civil partnership”, “separated”, “widowed”, “in a marital relationship”;

Question: “What is your total household income?”

Possible answers: “below 30,000 €”, “from 30,000 € to 50,000 €”, “from 50,000 € to 100,000 €”, “from 100,000 € to 150,000 €”, “from 150,000 € to 250,000 €”, “from 250,000 € to 500,000 €”, “more than 500,000 €”;

Question: “How much is the capital of your outstanding personal credits?” Possible answers: “no credit”, “below 50,000 €”, “comprised between 50,000 € and 200,000 €”, “comprised between 200,000 € and 500,000 €”, “more than 500,000 €”;

Question: “Have you suffered from a loss on your financial investments?”

Possible answers: “no, I have never suffered from a loss on my financial investments”, “yes, at most 10%”, “yes, at most 20%”, “yes, more than 20%”.

Step 110 of defining a questionnaire model by the financial actor enables the financial actor to fulfill its legal obligations regarding the client identification and knowledge, and to define an adapted model for each case, or to simply define a unique, and general, model applied to all users, irrespective of their economic profiles. In the latter case, step 110 of defining the questionnaire model may be carried out once by the financial actor for a determined user and omitted for the next users.

The definition of a questionnaire model by a financial actor according to step 110 may consist of a selection of questions identifiers and of questions labels. The identifiers may consist of order numbers, alphanumeric references or various codes, and the labels consist for example of names of sections, topics, or keywords.

Step 120 of querying a KYC by the financial actor is accompanied with sending of an identifier of the defined questionnaire model to the API.

When a financial actor asks for a KYC before a user via the API, said financial actor shall be able to identify the questionnaire model that will serve as a basis for the development of the KYC possibly amongst several models that it has defined beforehand. The financial actor then has an identifier for each defined questionnaire model, thereby enabling the API to find the model for which a KYC is requested.

Step 130 of transmitting the questionnaire model to the user by the API is characterised by sending either a truncated questionnaire model wherein only the questions that have no answers stored in the blockchain appear, or a model as defined by the financial actor with the addition of all of the answers corresponding to questions of the model and having been found in the blockchain. Thus, these default answers may be updated at any time by the user.

Step 140 of sending answers by the user to the API enables the API to collect the new information and answers that the blockchain does not have yet in order to complete the profile of the user in the blockchain.

During step 150, the API adds the answers given by the user to the blockchain. This step concerns sharing of data, in particular personal data, of the user in the blockchain and requires a contractual agreement. To this end, the execution of this step is governed by a smart-contract. For example, the Smart-contract monitoring this step is executed when the following two conditions are met: the user sends answers to the API (step 140) and the API checks up that said answers are not stored in the blockchain.

Other steps of the method according to the invention are monitored by Smart-contracts as will be seen later on.

Step 160 corresponds to an authorisation that the user grants to the financial actor so the latter could access the information provided in response to the defined questionnaire model. Afterwards, this authorisation allows triggering the next steps described hereinbelow. Furthermore, this step enables the user to fill his KYC in several steps and to proceed with the transmission thereof only when the information is completely filled in the questionnaire model defined by the financial actor. In addition, the authorisation of the user has a contractual nature required by regulations.

For example, this authorisation corresponds to the validation by the user of the truthfulness of the information compiled on a screen prior to their transmission to the financial actor.

Step 170 enables the API to send the questionnaire model defined by the financial actor to the blockchain and to register the authorisation given by the user on the blockchain, to enable the blockchain afterwards to apply the answers added to the added model. This step is monitored by a Smart-contract.

Step 180 ends with the creation of a KYC by the blockchain from the model and the registered answers. This KYC is time-and-date stamped and then stored in the blockchain. Storage of the different created KYC is necessary for the constitutions of evidences by either of the parties should a litigation arises, these files being characterised by a great reliability because of their multiple validations by the different nodes of the blockchain before time-and-date stamping and saving them. Step 180 is also monitored by a Smart-contract.

Lastly, step 190 enables the blockchain to send the time-and-date stamped KYC to the API, this step being monitored by a Smart-contract, and step 200 corresponds to the transmission of the time-and-date stamped KYC to the financial actor having requested it, this transmission is also monitored by a Smart-contract.

To conclude, the banking sector is the most concerned by the KYC notion and therefore, a fortiori, by the present invention. Nonetheless, for each business, in each business segment, customer knowledge is tremendous and is sometimes at the core of the strategy. It is obvious that the identification method as described may be adapted and modified yet without departing from the scope of the invention.

1-10. (canceled)

11. A method for electronic identification on a network of a first party before at least one second party, comprising
establishing a time-and-date stamped certified document of data relating to the first party in response to a query of said at least one second party, the query being sent on an application programming interface and comprising a plurality of requests to which the first party answers at least partially by sending answers via the application programming interface;
storing the answers in a blockchain; and
generating the time-and-date stamped certified document from the query of said at least one second party, the answers of the first party and previously stored answers in the blockchain.

12. The method of claim 11, wherein the answers provided by the first party correspond to a portion of the plurality of requests of the query, other portion of the plurality of request requests corresponding to the previously stored answers in the blockchain, the previously stored answers being provided by the first party in response to requests of another query.

13. The method of claim 11, wherein the previously stored answers in the blockchain being answers to requests of queries of other parties.

14. The method of claim 11, further comprising:
sending by said at least one second party a query on the application programming interface;
transmitting by the application programming interface the query to the first party;
sending by the first party the answers to at least one portion of the plurality of requests of the query;
adding by the application programming interface the answers to the blockchain;
sending by the application programming interface the query to said blockchain;
generating and storing by the blockchain the time-and-date stamped certified document corresponding to the answers of the first party to all of the plurality requests of the query, the query and all of answers stored in the blockchain;
sending by the blockchain the time-and-date stamped certified document to the application programming interface; and
transmitting by the application programming interface the time-and-date stamped certified documents to the second party.

15. The method of claim 14, further comprising monitoring by a smart-contract type program each of the following steps: sending by the application programming interface, generating and storing by the blockchain, sending by the blockchain, and transmitting by the application programming interface.

16. The method of claim 11, wherein the application programming interface sends a list of requests amongst which each second party selects a set of requests to define its query.

17. The method of claim 11, wherein the first party, each second party, the query and the time-and-date stamped certified document respectively comprises an investor, a financial institution, a customer knowledge questionnaire and a know your customer type customer knowledge report.

18. An electronic identification system, comprising an application programming interface and a blockchain, for an electronic identification on a network of a first party before at least one second party by:
establishing a time-and-date stamped certified document of data relating to the first party in response to a query of said at least one second party, the query being sent on an application programming interface and comprising a plurality of requests to which the first party answers at least partially by sending answers via the application programming interface;
storing the answers in a blockchain; and
generating the time-and-date stamped certified document from the query of said at least one second party, the answers of the first party and previously stored answers in the blockchain.

19. The system of claim 18, wherein the blockchain is a consortium blockchain in which each node is governed by said at least one second party.

20. The system of claim 18, wherein the application programming interface is accessible from a web page type consultation unit.
